(19) United States
(12) Patent Application Publication
(10) Pub. No.: US 2024/0069899 A1
(43) Pub. Date: Feb. 29, 2024

(54) SERVER, NON-TRANSITORY STORAGE MEDIUM, AND SOFTWARE UPDATE METHOD

(71) Applicant: TOYOTA JIDOSHA KABUSHIKI KAISHA, Toyota-shi (JP)

(72) Inventor: Tomoyasu ISHIKAWA, Nagoya-shi (JP)

(73) Assignee: TOYOTA JIDOSHA KABUSHIKI KAISHA, Toyota-shi (JP)

(21) Appl. No.: 18/351,590

(22) Filed: Jul. 13, 2023

(30) Foreign Application Priority Data
Aug. 30, 2022 (JP) 2022-136852

(51) Int. Cl. G06F 8/65

(52) U.S. Cl. CPC G06F 8/65

(57) ABSTRACT

A server configured to send data for updating software on a vehicle control device though wireless communication includes: one or more memories configured to store a program; and one or more processors. The one or more processors are configured to execute the program. The one or more processors are configured to set first data and second data. The first data is data to be displayed on an in-vehicle display in order to obtain user's approval to the software update. The second data is data to be displayed on user equipment in order to obtain the user's approval to the software update. The second data has higher information granularity than the first data.

### CROSS-REFERENCE TO RELATED APPLICATION

This application claims priority to Japanese Patent Application No. 2022-136852 filed on Aug. 30, 2022, incorporated herein by reference in its entirety.

### BACKGROUND

### 1. Technical Field

The present disclosure relates to servers, non-transitory storage media, and software update methods.

### 2. Description of Related Art

Over-The-Air (OTA) technology for updating software (vehicle control programs) stored in a vehicle control device (electronic control unit (ECU)) through wireless communication has been studied and developed. For example, Japanese Unexamined Patent Application Publication No. 2017-149323 (JP 2017-149323 A) discloses a vehicle control system capable of safely updating software without impairing user convenience. When it is determined that an electronic key of a vehicle is located inside the vehicle, a mobile device sends a signal requesting a download of update software to a server. An ECU downloads, via the mobile device, the update software sent from the server and updates the software.

### SUMMARY

Software updates on electrical devices such as personal computers and smartphones typically require user's approval. It is conceivable to obtain user's approval in advance of software updating on ECUs as well.

Software updates on electrical devices are mainly performed at user's home. On the other hand, software updates on ECUs are performed sometimes at user's home, and sometimes wherever the user is outside his or her home. It is desirable to appropriately provide data for obtaining user's approval to the user without impairing user convenience, regardless of the situation he or she is in when software is updated.

The present disclosure provides a technique of improving user convenience in software updates on ECUs.

(1) A server according to a first aspect of the present disclosure is configured to send data for updating software on a vehicle control device though wireless communication. The server includes: one or more memories configured to store a program; and one or more processors. The one or more processors are configured to execute the program and set first data and second data. The first data is data to be displayed on an in-vehicle display in order to obtain user's approval to the software update. The second data is data to be displayed on user equipment in order to obtain the user's approval to the software update. The second data has higher information granularity than the first data.

(2) In the server according to the first aspect of the present disclosure, an information amount of character information included in the second data may be greater than an information amount of character information included in the first data.

(3) In the server according to the first aspect of the present disclosure, the second data may include video information. The first data may not include the video information.

(4) In the server according to the first aspect of the present disclosure, the one or more processors may be configured to, when the user views part way through the second data using the user equipment and then further views the first data using the in-vehicle display, set the first data to be displayed on the in-vehicle display to be data following a part of the second data that has already been viewed using the user equipment.

(5) In the server according to the first aspect of the present disclosure, the one or more processors may be configured to, when the user views part way through the first data using the in-vehicle display and then further views the second data using the user equipment, set the second data to be displayed on the user equipment to be data following a part of the first data that has already been viewed using the in-vehicle display.

(6) In the server according to the first aspect of the present disclosure, the one or more processors may be configured to, when the user views part way through the first data using the in-vehicle display and then further views the second data using the user equipment, set the second data to be displayed on the user equipment to be data including a part of the first data that has already been viewed using the in-vehicle display.

(7) A non-transitory storage medium according to a second aspect of the present disclosure stores instructions that are executable by one or more computers in order to update software on a vehicle control device through wireless communication and that cause the one or more computers to perform functions. The functions include setting first data and second data. The first data is data to be displayed on an in-vehicle display in order to obtain user's approval to the software update. The second data is data to be displayed on user equipment in order to obtain the user's approval to the software update. The functions further include causing either or both of the in-vehicle display and the user equipment to display corresponding data out of the first data and the second data. The second data has higher information granularity than the first data.

(8) A software update method for updating software on a vehicle control device though wireless communication according to a third aspect of the present disclosure includes setting first data and second data. The first data is data to be displayed on an in-vehicle display in order to obtain user's approval to the software update. The second data is data to be displayed on user equipment in order to obtain the user's approval to the software update. The software update method further includes causing either or both of the in-vehicle display and the user equipment to display corresponding data out of the first data and the second data. The second data has higher information granularity than the first data.

With the present disclosure, user convenience can be improved in software updates on ECUs.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows a schematic configuration of an information processing system according to an embodiment of the present disclosure;

FIG. 2 is a block diagram showing a typical configuration example of an OTA center;

FIG. 3 is a block diagram showing a typical configuration example of a vehicle;

FIG. 4 is a block diagram showing a typical configuration example of user equipment;

FIG. 5 shows an example of a data structure of license information according to the embodiment;

FIG. 6 shows another example of the data structure of the license information according to the embodiment;

FIG. 7 is a flowchart showing a first example of a process of obtaining the user's approval to a software update;

FIG. 8 is a flowchart showing a second example of the process of obtaining the user's approval to a software update;

FIG. 9 is a flowchart showing a third example of the process of obtaining the user's approval to a software update; and

FIG. 10 is a flowchart showing a fourth example of the process of obtaining the user's approval to a software update.

### DETAILED DESCRIPTION OF EMBODIMENTS

Hereinafter, an embodiment of the present disclosure will be described in detail with reference to the drawings. The same or corresponding parts are denoted by the same signs throughout the drawings, and description thereof will not be repeated.

### Embodiment

System Configuration

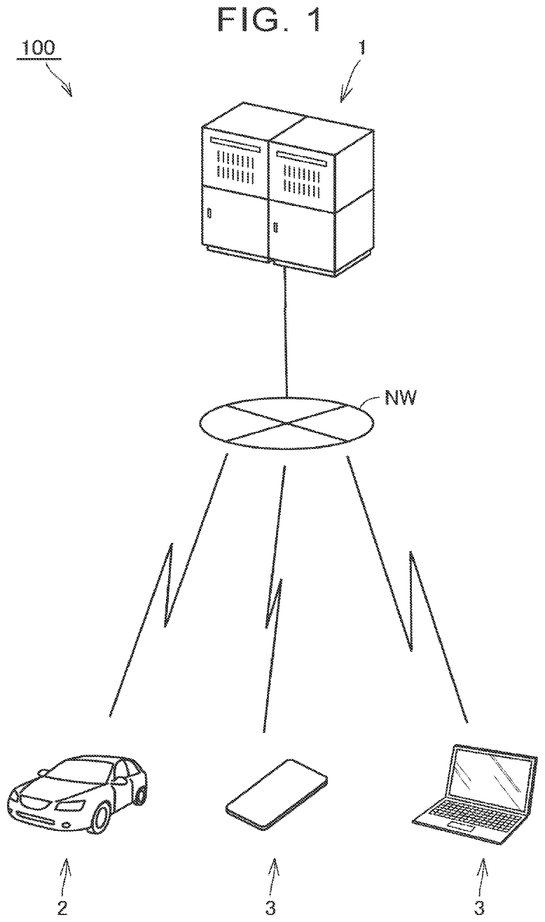

FIG. 1 shows a schematic configuration of an information processing system according to an embodiment of the present disclosure. An information processing system 100 includes an OTA center 1, a vehicle 2, and user equipment 3. The OTA center 1 is connected to the vehicle 2 and the user equipment 3 via a wired or wireless network NW so that the OTA center 1 can communicate with the vehicle 2 and the user equipment 3.

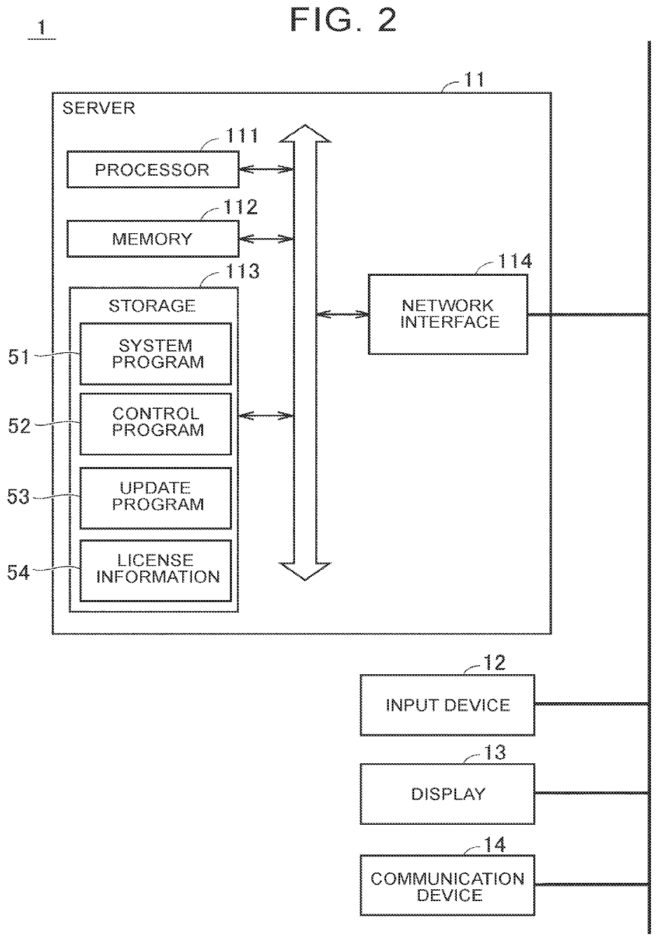

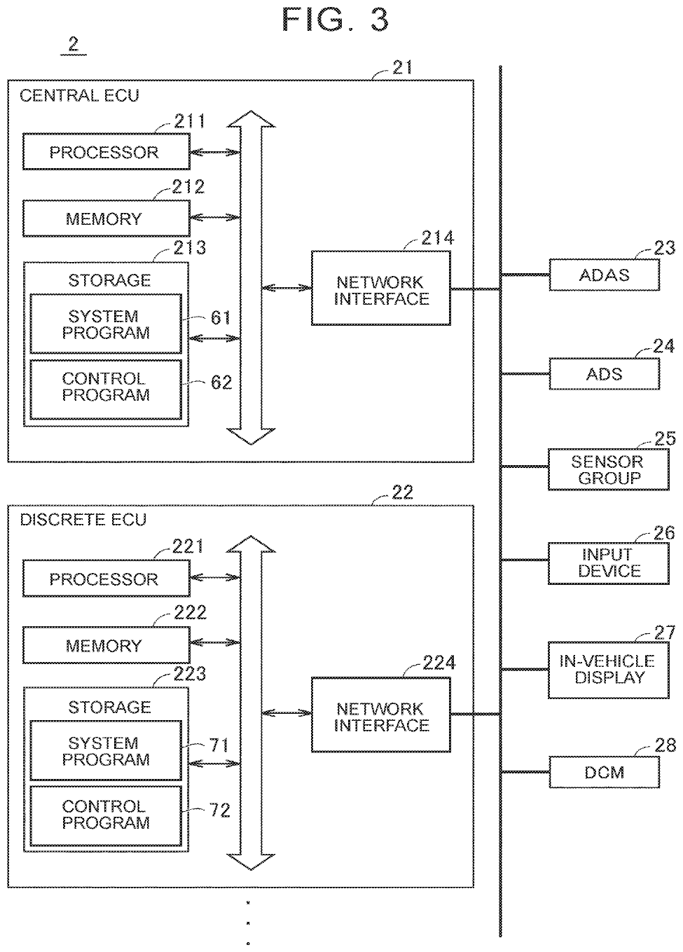

The OTA center 1 is a server that provides software for ECUs (see FIG. 3) mounted on the vehicle 2. The OTA center 1 is managed by, for example, a vehicle manufacturer that manufactures a vehicle platform (VP). The configuration of the OTA center 1 will be described later with reference to FIG. 2.

The vehicle 2 is managed by a user. The user is typically an individual. However, the user may be, for example, a cooperate body that conducts business using the vehicle 2 (a transport operator etc.). In the present embodiment, the vehicle 2 is an autonomous vehicle. In this case, the OTA center 1 may be managed by a manufacturer of an autonomous driving system (ADS) (see FIG. 3) mounted on the VP, instead of or in addition to the vehicle manufacturer. The vehicle 2 may be a vehicle that can only be manually driven and that does not support autonomous driving. The configuration of the vehicle 2 will be described later with reference to FIG. 3.

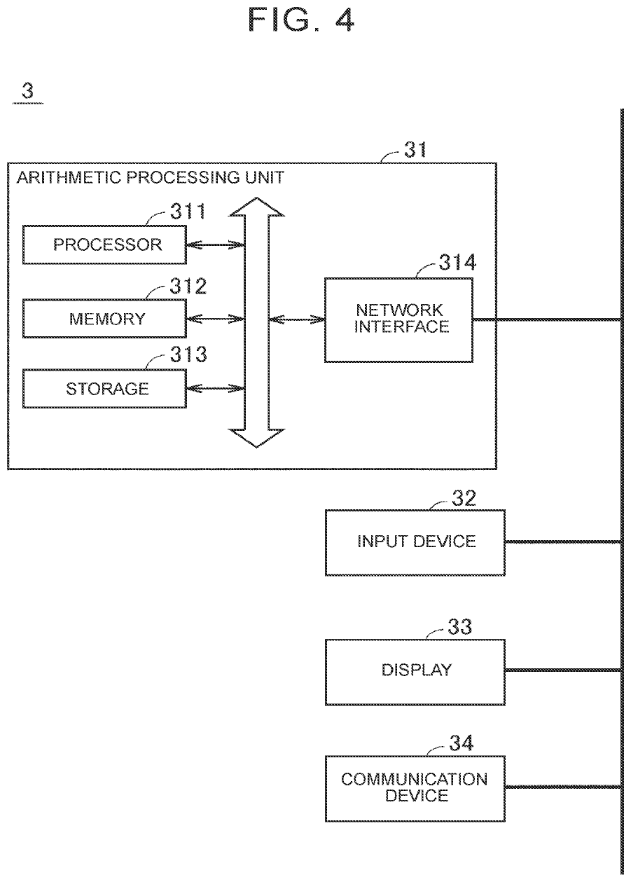

The user equipment 3 is equipment that is operated by the user of the vehicle 2. The user equipment 3 may be mobile equipment or stationary equipment. Examples of the mobile equipment include smartphones, tablets, laptops (notebook personal computers (PCs)), and wearable devices (smartwatches etc.). Examples of the stationary equipment include desktop PCs. The configuration of the user equipment 3 will be described later with reference to FIG. 4.

Only one vehicle 2 is shown in FIG. 1 due to space limitations. However, the information processing system 100 may include any number of vehicles 2. The information processing system 100 typically includes a large number of vehicles 2. The same applies to the user equipment 3.

FIG. 2 is a block diagram showing a typical configuration example of the OTA center 1. The OTA center 1 includes a server 11, an input device 12, a display 13, and a communication device 14. The server 11 includes a processor 111, a memory 112, a storage 113, and a network interface 114. The components of the OTA center 1 are connected to each other via a communication bus.

The storage 113 is a rewritable nonvolatile memory such as a hard disk drive (HDD), a solid state drive (SSD), or a flash memory. The storage 113 stores: a system program 51 including an operating system (OS); a control program 52 including computer-readable codes necessary for control calculations; an update program 53 for updating control programs for the vehicle 2; and license information 54 (will be described later) for obtaining the user's approval to a download, installation, etc. of the update program 53. The processor 111 is, for example, a central processing unit (CPU) or a micro-processing unit (MPU). The processor 111 reads the system program 51 and the control program 52 and loads them into the memory 112 to execute them. The processor 111 thus implements various processes. The network interface 114 controls data communication that is performed between the server 11 and other devices (vehicle 2, user equipment 3, etc.) via the communication device 14.

The input device 12 is a keyboard, a mouse, etc. The input device 12 receives input from an operator of the server 11. The display 13 displays various kinds of information to the operator of the server 11.

FIG. 2 shows an example in which the server 11 includes one processor 111. However, the server 11 may include a plurality of processors. That is, the server 11 includes one or more processors. The same applies to the memory 112 and the storage 113. That is, the server 11 includes one or more memories and one or more storages.

As used herein, the “processor” is not limited to a processor in a narrow sense that performs processes in a stored-program mode. The “processor” may include hardwired circuits such as application specific integrated circuits (ASICs) and field-programmable gate arrays (FPGAs). Therefore, the term “processor” may be read as processing circuitry whose processes are defined in advance by computer-readable codes and/or hardwired circuits.

FIG. 3 is a block diagram showing a typical configuration example of the vehicle 2. The vehicle 2 includes a central ECU 21, a plurality of discrete ECUs 22, advanced driver-assistance systems (ADAS) 23, an ADS 24, a sensor group 25, an input device 26, an in-vehicle display 27, and a Data Communication Module (DCM) 28. The discrete ECUs 22 are separate ECUs for each feature. The discrete ECUs 22 include, for example, a brake ECU, a steering ECU, a motor generator ECU, and a body ECU. The discrete ECUs 22 may be controllers storing software for implementing features of the ADAS 23 and/or the ADS 24. The components of the vehicle 2 are connected to each other via a wired in-vehicle network such as a controller area network (CAN) or in-vehicle Ethernet (registered trademark).

The basic configurations of the central ECU 21 and the discrete ECUs 22 are similar to the configuration of the server 11. A storage 223 of each discrete ECU 22 stores software (system program 71 and control program 72) that is executed by a processor 221 of the discrete ECU 22. Each discrete ECU 22 controls a system corresponding to the discrete ECU 22 so that the vehicle 2 goes into a desired state in response to signals from the sensor group 25 etc. As used herein, the system may include a braking system, a steering system, a powertrain system, a body system, etc., none of which are shown.

A processor 211 of the central ECU 21 controls update processes of software stored in the storages 223 of the discrete ECUs 22. The central ECU 21 receives (downloads) software from the OTA center 1 via the DCM 28. The central ECU 21 then stores (installs) the downloaded software in the storage 223 of the discrete ECU 22 at an appropriate timing. Thereafter, the central ECU 21 enables (activates) the installed software at an appropriate timing.

The ADAS 23 includes, for example, Adaptive Cruise Control (ACC), Auto Speed Limiter (ASL), Lane Keeping Assist (LKA), Pre-Crash Safety (PCS), and Lane Departure Alert (LDA). The ADS 24 is configured to perform autonomous driving of the vehicle 2.

The sensor group 25 includes sensors configured to detect the surroundings of the vehicle 2. The sensor group 25 further includes sensors configured to detect information on the driving state of the vehicle 2 and detect a steering operation, an accelerator operation, and a brake operation (none of such sensors are shown). Specifically, the sensor group 25 may include, for example, a camera, a radar, a Laser Imaging Detection and Ranging (LIDAR) sensor, a vehicle speed sensor, an acceleration sensor, a yaw rate sensor, and a steering sensor (none of which are shown).

The input device 26 is, for example, a touch panel provided on a multi-information display (MID). The input device 26 may be a physical switch or button. The in-vehicle display 27 is, for example, an MID. The in-vehicle display 27 may be an instrument panel. The DCM 28 is an in-vehicle communication module. The DCM 28 is configured to allow two-way data communication between the central ECU 21 and the server 11.

FIG. 4 is a block diagram showing a typical configuration example of the user equipment 3. The user equipment 3 includes an arithmetic processing unit 31, an input device 32, a display 33, and a communication device 34. The input device 32 and the display 33 are configured as an integrated unit such as a touch panel display. However, the input device 32 may be a dedicated input device (keyboard, mouse, etc.), and the display 33 may be a stationary monitor. Other configurations of the user equipment 3 are similar to the configurations of the server 11 (see FIG. 2).

User Approval

Software updates on the discrete ECUs 22 are performed sometimes at the user's home, and sometimes wherever the user is outside his or her home. In the present embodiment, information for obtaining the user's approval is presented to the user before a software update on the discrete ECU 22 is performed. This information is hereinafter referred to as “license information.” The license information includes, but is not limited to, information on a software license agreement. The license information may include information explaining the content of the software update, or may include information explaining how to use the vehicle 2 after the software update (so-called manual). The license information is an example of the “data” (first data and second data) according to the present disclosure.

It is desirable to appropriately provide the license information to the user without impairing user convenience. While it is possible to display the license information on the in-vehicle display 27 and/or the user equipment 3, the user equipment 3 is considered to be more suitable than the in-vehicle display 27. Many users search for and view various types of information (character information, video information, etc.) on a daily basis using the user equipment 3, and are familiar with how to operate the user equipment 3. In many cases, the user equipment 3 has good operability such as easy scrolling and easy pinching.

In the case where the license information is displayed in the same way on the user equipment 3 and the in-vehicle display 27, such uniformity may lead to a reduction in user convenience. Therefore, in the present embodiment, the information granularity of the license information is varied between the user equipment 3 and the in-vehicle display 27. More specifically, the OTA center 1 makes the information granularity of the license information to be displayed on the user equipment 3 higher than that of the license information to be displayed on the in-vehicle display 27. High information granularity means that various information elements are included in a set of information.

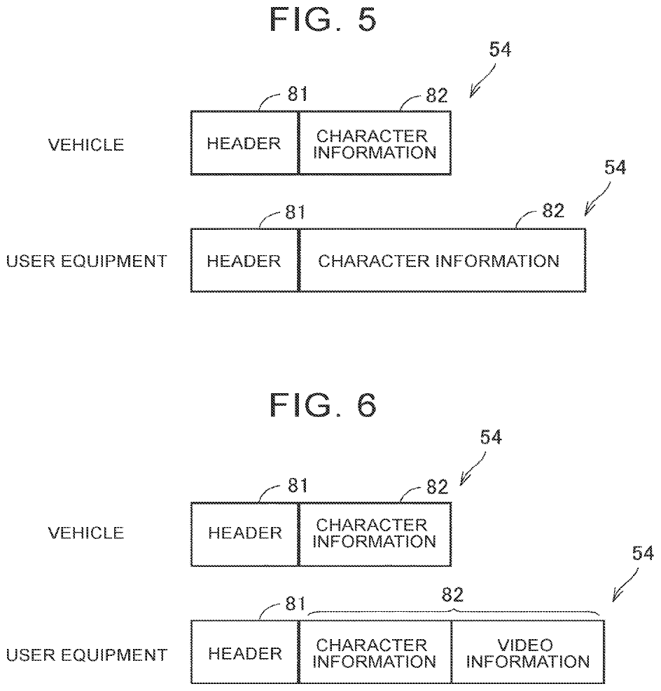

FIG. 5 shows an example of a data structure of the license information 54 according to the present embodiment. FIG. 6 shows another example of the data structure of the license information 54 according to the present embodiment. The license information 54 (see FIG. 2) stored in the storage 113 of the server 11 includes a header (metadata) 81 and a body (data body) 82. The header 81 may include a data creator, created date, title, tag, data type, data length, etc. The body 82 includes license information.

In the example shown in FIG. 5, the license information 54 includes character information for obtaining the user's approval to a software update. The amount of information (amount of description) in the character information to be displayed on the user equipment 3 is greater than the amount of information in the character information to be displayed on the in-vehicle display 27. As a specific example, the entire character information (e.g., items and detailed description of each item) is displayed on the user equipment 3. On the other hand, a particularly important part (e.g., items only, or items and brief description of each item) is extracted from the character information and displayed on the in-vehicle display 27. This is an example in which the information granularity of the license information 54 to be displayed on the user equipment 3 is high.

In the example shown in FIG. 6, the license information 54 to be displayed on the user equipment 3 includes video information in addition to the character information. The video information refers to an animation that visually explains the content of a software update, an animation that explains the procedure required for a software update (advance preparations, important notes, etc.), and a video manual on how to use the vehicle 2 after a software update. On the other hand, the license information 54 to be displayed on the in-vehicle display 27 includes the character information, but does not include the video information. This is another example in which the information granularity of the license information 54 to be displayed on the user equipment 3 is high.

As described above, in the present embodiment, the information granularity of the license information 54 to be displayed on the user equipment 3 is higher than that of the license information 54 to be displayed on the in-vehicle display 27. In other words, the amount of information in the license information 54 to be displayed on the user equipment 3 is greater than that in the license information 54 to be displayed on the in-vehicle display 27. The user can therefore give their approval to the software update after carefully checking the license information 54 on the user equipment 3. User convenience can thus be improved.

Process Flow

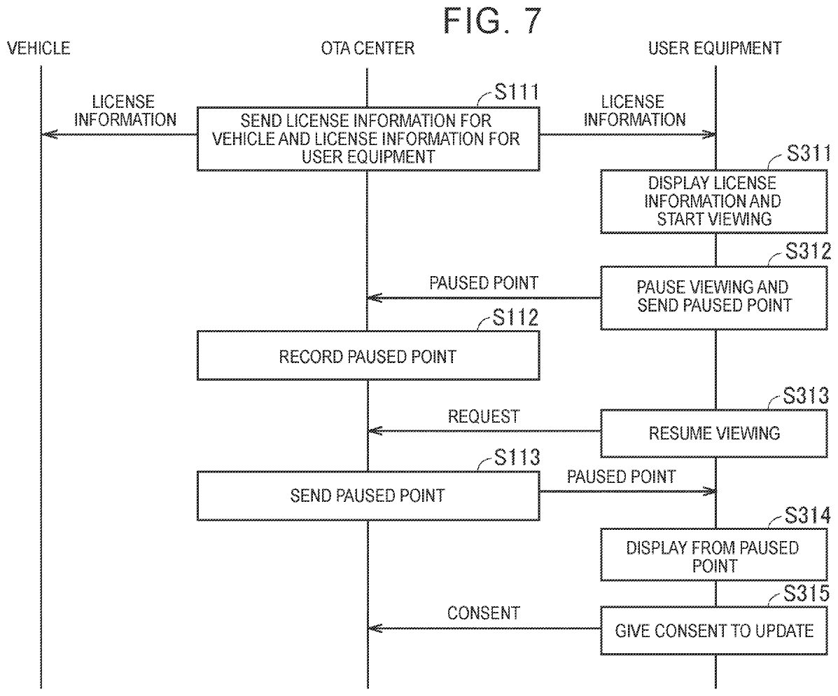

FIG. 7 is a flowchart showing a first example of a process of obtaining the user's approval to a software update. The process shown in this flowchart is performed when a predetermined condition is satisfied (for example, when software to be newly updated is registered in the OTA center 1). In the figure, the steps to be performed by the vehicle 2 are shown on the left side, the steps to be performed by the OTA center 1 are shown in the middle, and the steps to be performed by the user equipment 3 are shown on the right side. Hereinafter, the term “step” is abbreviated as “S.”

First, the OTA center 1 sends license information to be displayed on the in-vehicle display 27 to the vehicle 2, and also sends license information to be displayed on the display 33 of the user equipment 3 to the user equipment 3 (S111). The OTA center 1 may send the license information to the vehicle 2 and the user equipment 3 either at different times or substantially at the same time. The OTA center 1 may send the license information to the vehicle 2 in response to a request from the vehicle 2, and may send the license information to the user equipment 3 in response to a request from the user equipment 3. As described above with reference to FIGS. 5 and 6, the information granularity of the license information to be displayed on the display 33 of the user equipment 3 is higher than that of the license information to be displayed on the in-vehicle display 27.

In this example, the user operates the user equipment 3 to view the license information. The user equipment 3 thus displays the license information on the display 33 (S311).

There are case where the viewing of the license information is paused for some reason before the user performs an operation of giving their approval to the software update, such as when something urgent has come up for the user. In such a case, the user equipment 3 sends the paused point of the license information (information indicating how far the license information has been viewed) to the OTA center 1 (S312). When the OTA center 1 receives the paused point of the license information, the OTA center 1 records the received paused point in the storage 113 (S112).

The user resumes viewing the license information later, at a convenient time for the user. In this example, it is assumed that the user resumes viewing the license information using the user equipment 3. When the user equipment 3 receives a user operation of resuming the viewing, the user equipment 3 sends a request to resume the viewing to the OTA center 1 (S313). In response to the request sent by the user equipment 3, the OTA center 1 sends the paused point recorded in S112 to the user equipment 3 (S113). The user equipment 3 thus displays the license information from the paused point (S314).

When the user equipment 3 subsequently receives a user operation of giving their approval to the software update, the user equipment 3 sends the user's approval to the OTA center 1 (S315). A series of processes for updating the software (download, installation, and activation described above), not shown, is then performed in the vehicle 2.

As described above, in the case where the user pauses the viewing of the license information and then resumes the viewing, it is preferable that the paused point of the license information be taken over. With this configuration, the user does not have to re-view the part of the license information he or she has already viewed before pausing the viewing. Therefore, user convenience can further be improved.

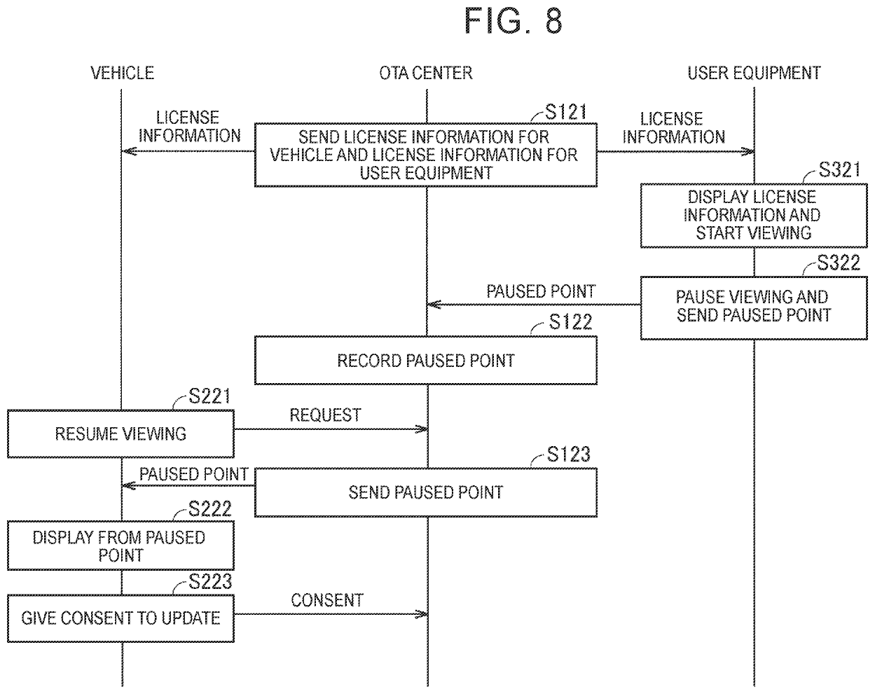

FIG. 8 is a flowchart showing a second example of the process of obtaining the user's approval to a software update. In this example, it is assumed that the user pauses the viewing of the license information using the user equipment 3 and then resumes viewing the license information using the vehicle 2 (in-vehicle display 27). The steps up to S122 are the same as the corresponding steps in FIG. 7. S121, S122 correspond to S111, S112, respectively. S321, S322 correspond to S311, S312, respectively.

When the vehicle 2 receives a user operation of resuming the viewing, the vehicle 2 sends a request to resume the viewing to the OTA center 1 (S221). In response to the request sent by the vehicle 2, the OTA center 1 sends the paused point recorded in S122 to the vehicle 2 (S123). The vehicle 2 displays the license information from the paused point on the in-vehicle display 27 (S222). When the vehicle 2 subsequently receives a user operation of giving their approval to the software update, the vehicle 2 sends the user's approval to the OTA center 1 (S223).

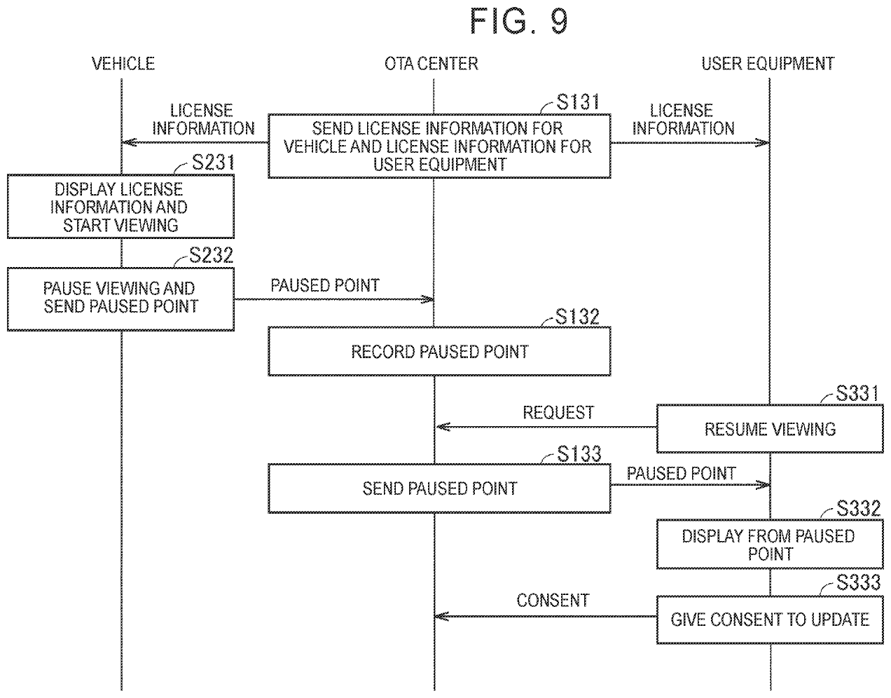

FIG. 9 is a flowchart showing a third example of the process of obtaining the user's approval to a software update. Although detailed description will not be repeated, the user equipment 3 and the vehicle 2 may be used in the opposite order to that shown in FIG. 8. Namely, as shown in FIG. 9, the license information may first be viewed on the vehicle 2, and the viewing of the license information may then be taken over by the user equipment 3. S131, S132 correspond to S121, S122, respectively. S133 corresponds to S123. In S133, however, the paused point is sent to the user equipment 3. S231, S232 correspond to S321, S322, respectively, but are performed by the vehicle 2. S331, S332, and S333 correspond to S221, S222, and S223, respectively, but are performed by the user equipment 3.

As described above, in the case where the user pauses the viewing of the license information and then resumes the viewing, it is preferable that the paused point of the license information be taken over even if the device used to view the license information is changed before and after the pause (in other words, regardless of whether the license information is viewed on the vehicle 2 or the user equipment 3). With this configuration, as same as FIG. 7, the user does not have to re-view the part of the license information he or she has already viewed before pausing the viewing. Therefore, user convenience can further be improved.

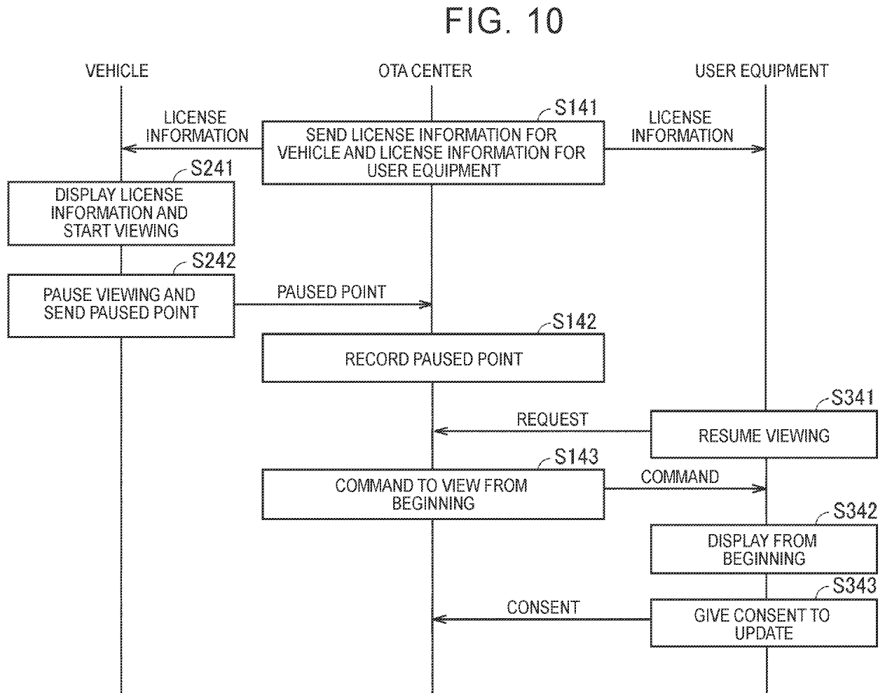

FIG. 10 is a flowchart showing a fourth example of the process of obtaining the user's approval to a software update. In FIG. 10 as well, when the viewing of the license information is paused on the vehicle 2, the paused point is recorded by the OTA center 1 (S142), as same as FIG. 9. The user then resumes viewing the license information using the user equipment 3. When the user equipment 3 receives a user operation of resuming the viewing, the user equipment 3 sends a request to resume the viewing to the OTA center 1 (S341). The OTA center 1 receives the request sent by the user equipment 3.

In this example, although the paused point is recorded in S142, the OTA center 1 sends to the user equipment 3 a command to view the license information from the beginning (S143). The user equipment 3 displays the license information from the beginning in response to the command (S342). When the user equipment 3 subsequently receives a user operation of giving their approval to the software update, the user equipment 3 sends the user's approval to the OTA center 1 (S343). S141 corresponds to S131. S241, S242 correspond to S231, S232, respectively.

As described above, in the case where the user pauses the viewing of the license information using the vehicle 2 and then resumes the viewing using the user equipment 3, the OTA center 1 may cause the user equipment 3 to display the entire license information from the beginning. The user can thus view the entire license information using the user equipment 3 that the user is familiar with and that has good operability. The user can therefore carefully and efficiently view the license information.

As described above, in the present embodiment, the information granularity of the license information is set so that the license information is displayed in a display mode suitable for the device in view of the proficiency in operation of each device and/or the operability of each device. More specifically, the information granularity of the license information to be displayed on the user equipment 3 is set to be higher than that of the license information to be displayed on the in-vehicle display 27. Accordingly, when the user uses the user equipment 3, the user can give their approval to the software update after carefully checking the license information. On the other hand, when the user uses the in-vehicle display 27, the user can give their approval to the software update after quickly checking the license information. With the present embodiment, user convenience can therefore be improved.

The embodiment disclosed herein should be construed as illustrative in all respects and not restrictive. The scope of the present disclosure is shown by the claims rather than by the above description of the embodiment and is intended to include all modifications within the meaning and scope equivalent to the claims.

What is claimed is:

1. A server configured to send data for updating software on a vehicle control device though wireless communication, the server comprising:
one or more memories configured to store a program; and
one or more processors configured to
execute the program, and
set first data and second data, the first data being data to be displayed on an in-vehicle display in order to obtain user's approval to the software update, the second data being data to be displayed on user equipment in order to obtain the user's approval to the software update, the second data having higher information granularity than the first data.

2. The server according to claim 1, wherein an information amount of character information included in the second data is greater than an information amount of character information included in the first data.

3. The server according to claim 1, wherein:
the second data includes video information; and
the first data does not include the video information.

4. The server according to claim 1, wherein the one or more processors are configured to, when the user views part way through the second data using the user equipment and then further views the first data using the in-vehicle display, set the first data to be displayed on the in-vehicle display to be data following a part of the second data that has already been viewed using the user equipment.

5. The server according to claim 1, wherein the one or more processors are configured to, when the user views part way through the first data using the in-vehicle display and then further views the second data using the user equipment, set the second data to be displayed on the user equipment to be data following a part of the first data that has already been viewed using the in-vehicle display.

6. The server according to claim 1, wherein the one or more processors are configured to, when the user views part way through the first data using the in-vehicle display and then further views the second data using the user equipment, set the second data to be displayed on the user equipment to be data including a part of the first data that has already been viewed using the in-vehicle display.

7. A non-transitory storage medium storing instructions that are executable by one or more computers in order to update software on a vehicle control device through wireless communication and that cause the one or more computers to perform functions, the functions comprising:
setting first data and second data, the first data being data to be displayed on an in-vehicle display in order to obtain user's approval to the software update, the second data being data to be displayed on user equipment in order to obtain the user's approval to the software update; and
causing either or both of the in-vehicle display and the user equipment to display corresponding data out of the first data and the second data, the second data having higher information granularity than the first data.

8. A software update method for updating software on a vehicle control device though wireless communication, the software update method comprising:
setting first data and second data, the first data being data to be displayed on an in-vehicle display in order to obtain user's approval to the software update, the second data being data to be displayed on user equipment in order to obtain the user's approval to the software update; and
causing either or both of the in-vehicle display and the user equipment to display corresponding data out of the first data and the second data, the second data having higher information granularity than the first data.
